(19) United States
(12) Patent Application Publication
(10) Pub. No.: US 2009/0190696 A1
(43) Pub. Date: Jul. 30, 2009

(54) METHOD AND SYSTEM FOR ESTIMATING PARAMETERS OF A MULTI-TONE SIGNAL

(76) Inventor: Serge Provencher, Montreal (CA)

Correspondence Address: POLSINELLI SHUGHART PC, 700 W. 47TH STREET, SUITE 1000, KANSAS CITY, MO, 64112-1802, US

(21) Appl. No.: 12/327,186

(22) Filed: Dec. 3, 2008

Related U.S. Application Data
(60) Provisional application No. 60/996,891, filed on Dec. 10, 2007.

(51) Int. Cl. H04L 27/06

(52) U.S. Cl. 375/340

(57) ABSTRACT

There is provided a method and a system for estimating parameters of a multi-tone signal made up of at least one single-tone signal, wherein the method comprises: generating time samples of the multi-tone signal by using a sampler; calculating the discrete Fourier transform (DFT) frequency samples by using a processing unit; calculating an intermediate vector from the calculated discrete Fourier transform (DFT) frequency samples by using the processing unit; defining coefficients of a polynomial from the components of the intermediate vector; calculating the roots of the polynomial by using the processing unit; calculating an amplitude-related vector from at least the roots of the polynomial by using the processing unit; and calculating estimates of the parameters of the multi-tone signal from the roots of the polynomial and the amplitude-related vector.

### CROSS-REFERENCE TO RELATED APPLICATION

The present application claims the benefits of U.S. provisional patent application No. 60/996,891 filed Dec. 10, 2007, which is hereby incorporated by reference.

### TECHNICAL FIELD

The present invention is generally concerned with a method and system for estimating parameters of a multi-tone signal, and more particularly with estimating frequencies and amplitudes of single-tone signals making up a multi-tone signal.

### BACKGROUND

Multi-tone signals are encountered in various fields, such as speech processing, telecommunications, radar and sonar technologies, remote controlling, seismology, geophysical morphology, estimation of arrival direction, the characterization of biological tissues, music, vibration control and astronomy.

A multi-tone signal s(t) is a signal that is made up of M tones, each tone being characterized by a frequency f and a complex amplitude A. For the case of a real signal, the complex amplitude A can also be characterized by a real amplitude E and a phase φ.

Indeed, either in real or complex form, a multi-tone signal comprising M tones is described by M complex parameters and M real parameters.

However, most of the time, the 2M parameters are not known; instead, time samples of the signal are available, from which the parameters are to be estimated.

Estimating parameters of a multi-tone signal is a well known problem [1], the complexity of which arises as a result of the multi-tone signal's model being a nonlinear model, since an inversion method of such a model can often be tedious or even unknown or unavailable.

Various approaches for estimating the parameters have been used in order to circumvent the inversion problem, for example methods using the covariance matrix [2] [3] [4], linear prediction [5] [6], ARMA models [7] and Discrete Fourier Transform (DFT).

A major drawback for the existing methods for estimating the parameters of a multi-tone signal is that the computing time increases with the precision required for the estimated parameters. As a result, real-time applications that have to estimate the parameters of a multi-tone signal typically have to make a compromise between precision and resolution time. Moreover, such real-time applications typically are performed in a context where computing power is limited, for example because processors pertaining thereof are limited or many signals are simultaneously processed, and a result thereof must be provided rapidly.

Therefore, there is a need for a method for estimating parameters of a multi-tone signal that is precise and requires little computing time, i.e. CPU time.

### SUMMARY

According to the present invention, there is provided a method and system for estimating parameters of a multi-tone signal made up of at least one single-tone signal, each single-tone signal being characterized by a frequency and a complex amplitude.

More specifically, in accordance with the present invention, there is provided a method for estimating the frequency and the amplitude of each single-tone signal making up a multi-tone signal, comprising the steps of:
generating time samples of the multi-tone signal;
calculating Discrete Fourier Transform frequency samples from the time samples;
building a system of linear equations from the frequency samples;
defining an intermediate vector from a solution of the system of linear equations;
defining coefficients of a polynomial from components of the intermediate vector;
calculating roots of the polynomial;
calculating an amplitude-related vector from at least the roots of the polynomial;
calculating the estimate of the frequency of each single-tone signal from the roots of the polynomial;
calculating the estimate of the amplitude of each single-tone signal from the amplitude-related vector; and
as an optional feature, calculating the reconstructed DFT frequency samples from the estimated frequencies and amplitudes of the multi-tone signal.

According to a second aspect of the present invention, there is provided a system for estimating the frequency and the amplitude of each single-tone signal making up a multi-tone signal, the system comprising:
a sampler for generating time samples of the multi-tone signal;
an input/output interface; and
a processing unit operatively connected to the sampler and the input/output interface, the processing unit being so configured as to:
   calculating Discrete Fourier Transform frequency samples from the time samples generated by the sampler;
   building a system of linear equations from the frequency samples;
   defining an intermediate vector from a solution of the system of linear equations;
   defining coefficients of a polynomial from components of the intermediate vector;
   calculating roots of the polynomial;
   calculating an amplitude-related vector from at least the roots of the polynomial;
   calculating the estimate of the frequency of each single-tone signal from the roots of the polynomial;
   calculating the estimate of the amplitude of each single-tone signal from the amplitude-related vector;
   providing the estimated frequencies and the estimated amplitudes to the input/output interface; and
   as an optional feature, calculating and providing the reconstructed DFT frequency samples from the estimated frequencies and amplitudes of the multi-tone signal.

The multi-tone signal can be either a real signal or a complex signal. In the former case, the multi-tone signal is typically made up of real single-tone signals, each of which is characterized by a real frequency and a complex amplitude or, alternatively, by a real frequency, a real amplitude and a real phase; in the latter case, the multi-tone signal is typically made up of complex single-tone signals, each of which is characterized by real frequency and a complex amplitude.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The foregoing and other objects, advantages and features of the present invention will become more apparent upon reading of the following non-restrictive description of illustrative embodiments.

### BRIEF DESCRIPTION OF THE DRAWINGS

Non-limitative illustrative embodiments of the invention will now be described by way of example only with reference to the accompanying drawings, in which:

FIG. 1 is a schematic representation of a system for estimating parameters of a multi-tone signal according to an illustrative embodiment of the present invention;

FIG. 2 is a flow diagram of a general process for estimating parameters of a multi-tone signal according to an illustrative embodiment of the present invention;

FIG. 3 is a flow diagram of a first illustrative embodiment of the general process of FIG. 2 applied to a complex multi-tone signal;

FIG. 4 is a flow diagram of a second illustrative embodiment of the general process of FIG. 2 applied to a real multi-tone signal;

FIG. 5 is a flow diagram of a third illustrative embodiment of the general process of FIG. 2 applied to a complex multi-tone signal; and

FIG. 6 is a flow diagram of a fourth illustrative embodiment of the general process of FIG. 2 applied to a real multi-tone signal.

### NOTATION

Throughout the specification pertaining to the present invention, the notation presented hereinbelow will be used.

A superscript “*” indicates a complex conjugate and the superscript “^{T}” indicates the transpose of a matrix or a vector. For a complex number z, Re{z} and Im{z} are respectively the real part and the imaginary part of z. The notation D=diag{d₀ d₁, . . . } indicates a diagonal matrix D, the values on the diagonal of which are d₀, d₁, . . . , all other elements of the matrix being zero.

$${u}_{k} = cos ( \frac{2 π k}{N} ) \\ {v}_{k} = sin ( \frac{2 π k}{N} ) \\ {w}_{k} = {e}^{- j \frac{2 π k}{N}} = {u}_{k} - j {v}_{k} \\ {λ}_{m} = {e}^{j 2 π {f}_{m} T} \\ {μ}_{m} = cos ( 2 π {f}_{m} T ) = Re \{ {λ}_{m} \} \\ {v}_{m} = sin ( 2 π {f}_{m} T ) = Im \{ {λ}_{m} \} \\ {p}_{m} = {A}_{m} ( 1 - {λ}_{m}^{N} ) \\ {q}_{m} = Re \{ {p}_{m} \} \\ {r}_{m} = Re \{ {p}_{m} {λ}_{m}^{*} \} \\ {S}_{r} ( k ) = Re \{ S ( k ) \} \\ {S}_{i} ( k ) = Im \{ S ( k ) \} \\ ‖ S ( k ) ‖ = S ( k ) {S}^{*} ( k ) , \\ wherein \\ j = \sqrt{- 1} . \qquad Equation 1$$

Furthermore, the notation S(k,l) means the Discrete Fourier Transform (DFT) frequency sample of index k of a DFT of length N associated with time frame l using time samples s(lt),s([l+1]t), . . . , s([l+N−1]t).

### DETAILED DESCRIPTION

Generally stated, the non-limitative illustrative embodiment of the present invention provides a method and system for estimating parameters of a multi-tone signal, and more particularly with estimating frequencies and amplitudes of single-tone signals making up a multi-tone signal.

A multi-tone signal is made up of at least one single-tone signal, each of which being characterized by a real frequency f and a complex amplitude A.

More specifically, for a complex single-tone signal:

s(t)=Ae^{j2πft}. Equation 2

A real single-tone signal s(t) can be viewed as the sum of a first complex signal and a second complex signal, wherein to a given complex single-tone signal corresponds another complex single-tone signal, the amplitude of which is the conjugate of the given single-tone signal and the frequency of which is the negative of the frequency of the given single-tone signal.

More specifically, for a real single-tone signal:

s(t)=Ae^{j2πft}+A*e^{-j2πft}. Equation 3

A real single-tone signal can also be characterized by a real frequency f, a real amplitude E and a phase φ:

s(t)=E cos(2πft+φ). Equation 4

The real parameters E and φ and the complex parameter A are related by:

$$E = {2 [ Re {\{ A \}}^{2} + Im {\{ A \}}^{2} ]}^{\frac{1}{2}} \\ φ = {tan}^{- 1} ( \frac{Im \{ A \}}{Re \{ A \} } ) \\ Re \{ A \} = \frac{E}{2} cos ( φ ) \\ Im \{ A \} = \frac{E}{2} sin ( φ ) . \qquad Equation 5$$

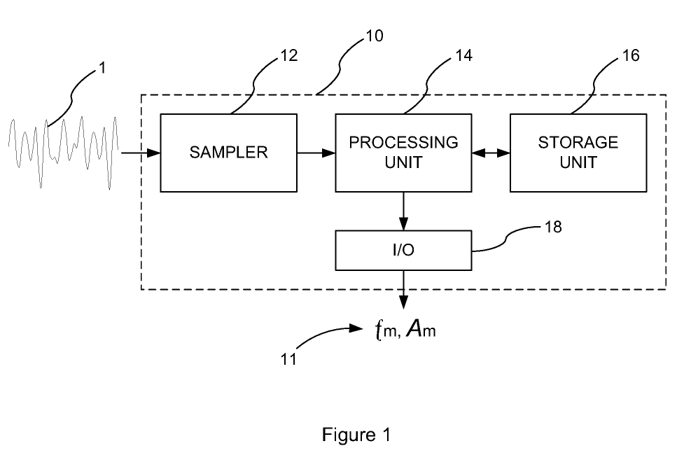

Referring to FIG. 1, there is shown a schematic representation of a system 10 for estimating parameters 11 of a multi-tone signal 1 according an the illustrative embodiment of the present invention. The system 10 comprises a sampler 12 for sampling a multi-tone signal 1, a processing unit 14 for performing the parameters estimation process, an optional storage unit 16 for storing results of intermediate calculations or the estimated parameters 11 of the multi-tone signal 1, and an input/output interface 18 for providing the estimated parameters 11 to, for example, another device for further treatment, a display, etc. The parameters 11, namely frequencies fₘ and amplitudes Aₘ, can then be used for reconstructing the multi-tone signal 1.

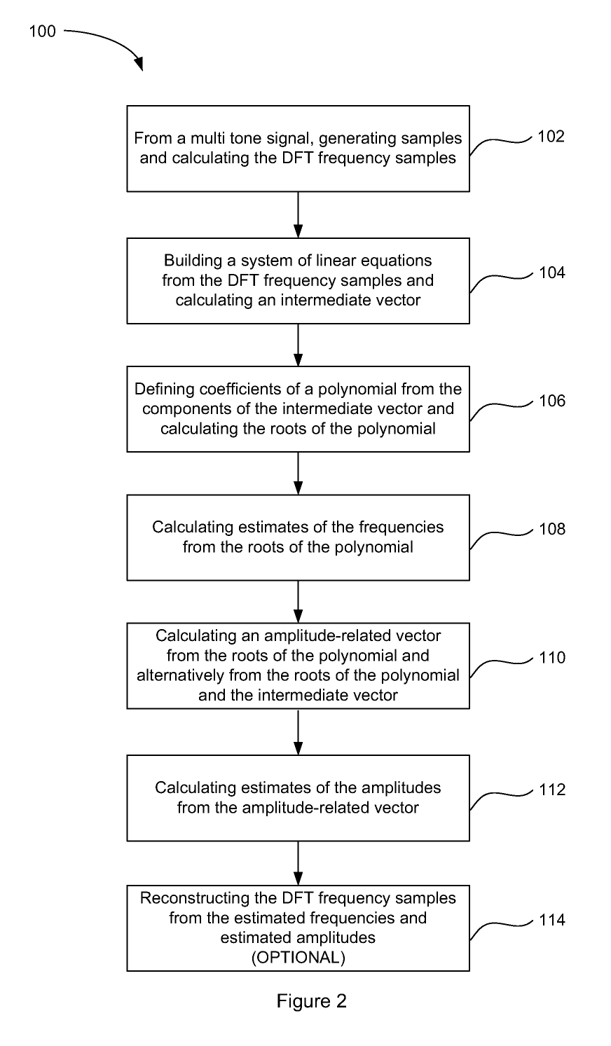

Referring now to FIG. 2, there is shown a flow diagram of an illustrative embodiment of a general process 100 that can be executed by the processing unit 14 to estimate the parameters of the multi-tone signal 1. The steps of the process 100 are indicated by blocks 102 to 114.

The process 100 starts at block 102 where time samples of the multi-tone signal 1 are generated by using the sampler 12 and the Discrete Fourier Transform (DFT) frequency samples of the time samples are calculated.

At block 104, a system of linear equations is built from the calculated DFT frequency samples, the solution of the system of linear equations is calculated and an intermediate vector is defined from the solution of the system of linear equations.

At block 106, the coefficients of a polynomial are defined from the components of the intermediate vector and the roots of the polynomial are calculated.

At block 108, estimates of the frequencies are calculated from the roots of the polynomial.

At block 110, an amplitude-related vector is calculated from the roots of the polynomial or from the intermediate vector of block 104 and the roots of the polynomial, depending on the specific implementation.

At block 112, estimates of the amplitudes are calculated from the amplitude-related vector.

At block 114, as an optional feature, the DFT frequency samples of the multi-tone signal can be reconstructed from the estimated frequencies and amplitudes of the multi-tone signal.

The general process 100 will be further detailed using four non-restrictive illustrative embodiments. The first and third illustrative embodiments are concerned with a complex multi-tone signal, whereas the second and fourth illustrative embodiments are concerned with a real multi-tone signal.

However, it is to be understood that a real multi-tone signal, as it is known by those skilled in the art, can be represented as the sum of complex single-tone signals, each real single-tone signal being the sum of two complex single-tone signals. Therefore, it is possible to also use the first and third alternative illustrative embodiments for estimating parameters of a real multi-tone signal.

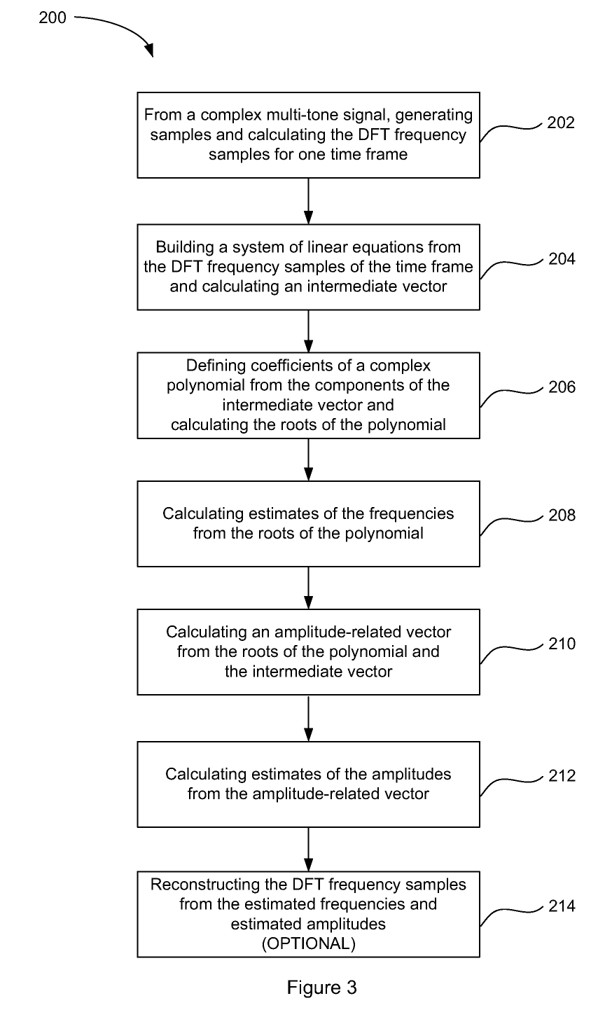

Referring to FIG. 3, the process 200 for estimating parameters of a complex multi-tone signal s(t) made up of at least one single-tone signal will now be described according to the first non-restrictive illustrative embodiment of process 100. The steps of the process 200 are indicated by blocks 202 to 214.

It is to be understood that blocks 202 to 214 of process 200 are specific implementations of the associated general blocks 102 to 114 of process 100 from FIG. 2.

The process 200 starts at block 202 where a sampling period T for sampling the signal s(t) is chosen. From an arbitrary reference time t=0, the sampling can be made at times . . . , −2T, −T, 0, T, 2T, . . . so as to get the signal time samples s(nT), wherein n= . . . , −2, −1, 0, 1, 2, . . . .

Accordingly, using N time samples s(nT), with n=0, 1, 2, . . . , N−1, DFT frequency samples S(k) are calculated for integer values of k, 0≦k<N, wherein:

$$S ( k ) = {\sum }_{n = 0}^{N - 1} s ( nT ) {e}^{- j \frac{2 π kn}{N}} . \qquad Equation 6$$

In the present illustrative embodiment, N is chosen so that N≧2M.

At block 204, a system of linear equations is built. 2M DFT frequency samples are selected from the N possible DFT frequency samples of block 202 hereinabove. The 2M frequency samples are indexed by k₀, k₁, . . . , k_{2M-1}. It is to be noted that in general, an index of the 2M frequency samples is denoted by kᵢ.

More specifically, the resulting system of linear equations is:

g=[YΘY]h Equation 7

wherein:
g=[S(k₀) S(k₁) . . . S(k_{2M-1})]^{T}
h=[h₀ h₂ . . . h_{2M-1}]^{T}
Θ=diag{θₖ_{₀}, θₖ_{₁}, . . . , θₖ_{_{2M-1}}};
Y=[yₖ_{₀} yₖ_{₁} . . . yₖ_{_{2M-1}}]^{T}
θₖ_{ᵢ}=−S(kᵢ)wₖ_{ᵢ}
yₖ_{ᵢ}=[1 wₖ_{ᵢ} wₖ_{ᵢ}² . . . wₖ_{ᵢ}^{M-1}]^{T}; i=0, 1, . . . , 2M−1.

The solution of the system of linear equations is then calculated and the intermediate vector [a b]^{T} is defined such that:

$$[ \begin{matrix}a \\ b\end{matrix} ] = h = {[ Y Θ Y ]}^{- 1} g \\ wherein \text{:} \\ a = {[ {a}_{0} {a}_{1} … {a}_{M - 1} ]}^{T} \\ b = {[ {b}_{1} {b}_{2} … {b}_{M} ]}^{T} . \qquad Equation 8$$

It is to be noted that indices of vector a range from 0 to M−1, whereas indices of vector b range from 1 to M.

The components of vector b are to be used as coefficients for defining a complex polynomial.

At block 206, the coefficients of the polynomial are defined and the roots of the polynomial are calculated. From the vector b as defined hereinabove in block 204, the following complex polynomial is defined, wherein z is a complex variable:

$${z}^{M} + {\sum }_{n = 1}^{M} {b}_{n} {z}^{M - n} = 0. \qquad Equation 9$$

The roots zₘ of the complex polynomial are then calculated, wherein m=0, 1, . . . M−1.

Then, at block 208, estimates of the frequencies fₘ, wherein m=0, 1, . . . , M−1, are calculated from the following equation:

zₘ=λₘ=e^{j2πf}^{ₘ}^{T}. Equation 10

At block 210, a vector p pertaining to amplitudes is calculated, such that:

C⁻¹a=p, Equation 11

wherein vector a is defined at block 204 and C is a M×M matrix, the elements of which are each defined by:

$${c}_{m , n} = \{ \begin{matrix}1 & n = 0 \\ {b}_{n} + {λ}_{m} {c}_{m , n - 1} & n = 1 , 2 , … , M - 1 ,\end{matrix} \qquad Equation 12$$

wherein c_{m,n} is an element of C on line n column m; and

p=[p₀p₁ . . . p_{M-1}]^{T}.

At block 212, from the components of vector p calculated in block 210 hereinabove, estimates of the M complex amplitudes Aₘ, wherein m=0, 1, . . . , M−1, are calculated from the following equation:

$${A}_{m} = \frac{{p}_{m}}{1 - {λ}_{m}^{N}} . \qquad Equation 13$$

At this point, all the parameters of the complex multi-tone signal have been estimated, i.e. the M real frequencies fₘ and the M complex amplitudes Aₘ have been calculated.

At block 214, as an optional feature, the DFT frequency samples can be reconstructed from the estimated frequencies and amplitudes of the multi-tone signal. For each complex single-tone signal sₘ(t)=Aₘe^{j2πf}^{ₘ}^{t}, m=0, 1, . . . , M−1, of a multi-tone signal

$$s ( t ) = {\sum }_{m = 0}^{M - 1} {s}_{m} ( t ) ,$$

the N DFT frequency samples Sₘ(k), k=0, 1, . . . , N−1, are reconstructed using:

$${S}_{m} ( k ) = \frac{{p}_{m}}{1 - {w}_{k} {λ}_{m}} . \qquad Equation 14$$

Sₘ(k) as defined hereinabove is the projection of the complex single-tone of index m on the kₜₕ vector of the transformation matrix of the DFT of length N.

For a complex multi-tone signal, the N DFT frequency samples S(k), k=0, 1, . . . , N−1 can be reconstructed using:

$$S ( k ) = {\sum }_{m = 0}^{M - 1} {S}_{m} ( k ) \\ S ( k ) = \frac{{\sum }_{m = 0}^{M - 1} {a}_{m} {w}_{k}^{m}}{1 + {\sum }_{m = 1}^{M} {b}_{m} {w}_{k}^{m}} \qquad Equation 15$$

wherein Sₘ (k) is defined hereinabove, aₘ are the elements of vector a and bₘ₊₁ are the elements of vector b, m=0, 1, . . . , M−1, vector a and vector b being defined at block 204.

S(k) as defined hereinabove for a multi-tone signal is the projection of the complex multi-tone signal on the kₜₕ vector of the transformation matrix of the DFT of length N.

For the case of a complex single-tone signal with frequency f, using DFT frequency samples of index k₀ and k₁, with k₀<k₁, the frequency f can be obtained using:

$$cot ( π [ \frac{{k}_{0}}{N} - fT ] ) = {Y}^{- 1} g ; \\ g = {[ \frac{‖ S ( {k}_{0} ) ‖}{‖ S ( {k}_{1} ) ‖} ]}^{\frac{1}{2}} - cos ( \frac{( {k}_{1} - {k}_{0} ) π}{N} ) \\ Y = sin ( \frac{( {k}_{1} - {k}_{0} ) π}{N} ) \qquad Equation 16$$

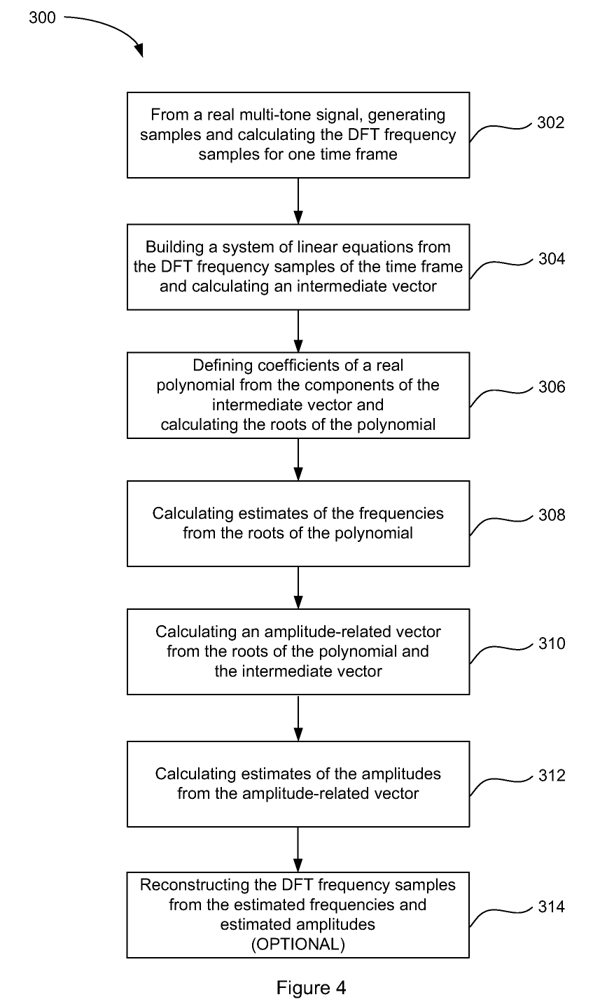

A second non-restrictive illustrative embodiment of the process 100 of FIG. 2 will now be described in FIG. 4 as process 300. Process 300 is used for estimating parameters of a real multi-tone signal s(t) made up of at least one single-tone signal.

It is to be noted that process 300 is adapted from process 200, since a real single-tone signal s(t) can always be viewed as the sum of a first complex signal and a second complex signal, wherein to a given complex single-tone signal corresponds another complex single-tone signal, the amplitude of which is the conjugate of the given single-tone signal and the frequency of which is the negative of the frequency of the given single-tone signal.

Referring to FIG. 4, the process 300 for estimating parameters of a real multi-tone signal s(t) made up of at least one single-tone signal will now be described according to the second non-restrictive illustrative embodiment of process 100. The steps of the process 300 are indicated by blocks 302 to 314.

It is to be understood that blocks 302 to 314 of process 300 are specific implementations of the associated general blocks 102 to 114 of process 100 from FIG. 2.

The process 300 starts at block 302 where time samples of the multi-tone signal are generated and the DFT frequency samples are calculated. This is accomplished similarly to block 202 of process 200 of FIG. 3 with the exception that the signal s(t) is a real signal made up of M real single-tone signals, each of which is characterized by a real frequency fₘ and a complex amplitude Aₘ, and N is chosen so that N≧3M.

At block 304, a system of linear equations is built and an intermediate vector is defined. The calculated DFT frequency samples of block 302 are divided into two sets βᵣₑ and βᵢₘ of real values: a first set is made up of the real parts of the calculated DFT frequency samples, whereas the second set is made up of the imaginary parts of the calculated DFT frequency samples.

More specifically, in the case of N being even,

$${β}_{re} \text{:} \{ Re \{ S ( 0 ) \} , Re \{ S ( 1 ) \} , … , Re \{ S ( \frac{N}{2} ) \} \}$$

$${β}_{im} \text{:} \{ Im \{ S ( 1 ) \} , Im \{ S ( 2 ) \} , … , Im \{ S ( \frac{N}{2} - 1 ) \} \} ;$$

and in the case of N being odd,

$${β}_{re} \text{:} \{ Re \{ S ( 0 ) \} , Re \{ S ( 1 ) \} , … , Re \{ S ( \frac{N - 1}{2} ) \} \}$$

$${β}_{im} \text{:} \{ Im \{ S ( 1 ) \} , Im \{ S ( 2 ) \} , … , Im \{ S ( \frac{N - 1}{2} ) \} \} .$$

Process 300 can be put into practice by choosing elements either from βᵣₑ or βᵢₘ, as described hereinbelow.

Mᵣₑ elements are chosen from βᵣₑ and Mᵢₘ elements are chosen from βᵢₘ, wherein Mᵣₑ+Mᵢₘ=3M. The 3M elements are indexed by k₀, k₁, . . . , k_{3M-1}. It is to be noted that in general, an index of the 3M elements is denoted by kᵢ.

From the 3M elements, a system of linear equations is built:

g=[Θ₀Y Θ₁Y Θ₂Y]h, Equation 17

wherein:
g=[g₀ g₁ . . . g_{3M-1}]^{T}
h=[h₀ h₁ . . . h_{3M-1}]^{T}
Θ₀=diag{θ_{0,0}θ_{0,1} . . . θ_{0,3M-1}}
Θ₁=diag{θ_{1,0}θ_{1,1} . . . θ_{1,3M-1}};
Θ₂=diag{θ_{2,0}θ_{2,1} . . . θ_{2,3M-1}}
Y=[yₖ_{₀} yₖ_{₁} . . . yₖ_{_{3M-1}}]^{T}
yₖ_{ᵢ}=[1 uₖ_{ᵢ}⁻¹ uₖ_{ᵢ}⁻² . . . uₖ_{ᵢ}^{-(M-1)}]^{T}; and
gᵢ=Re{S(kᵢ)}uₖ_{ᵢ}
θ_{0,i}=uₖ_{ᵢ} for the elements chosen from βᵣₑ,
θ_{0,i}=−1
θ_{2,i}=−Re{S(kᵢ)}
gᵢ=Im{S(kᵢ)}uₖ_{ᵢ},
θ_{0,i}=vₖ_{ᵢ} for the elements chosen from βᵢₘ,
θ_{1,i}=0
θ_{2,i}=−Im{S(kᵢ)}
   for i=0, 1, . . . , 3M−1.

The solution of the system of linear equations is then calculated and an intermediate vector [a b c]^{T} is defined, such that:

$$[ \begin{matrix}a \\ b \\ c\end{matrix} ] = h = {[ {Θ}_{0} Y {Θ}_{1} Y {Θ}_{2} Y ]}^{- 1} g , \\ wherein \text{:} \\ a = {[ {a}_{0} {a}_{1} … {a}_{M - 1} ]}^{T} \\ b = {[ {b}_{0} {b}_{1} … {b}_{M - 1} ]}^{T} . \\ c = {[ {c}_{1} {c}_{2} … {c}_{M} ]}^{T} \qquad Equation 18$$

At block 306, the coefficients of a polynomial are defined and the roots of the polynomial are calculated. From the vector c as defined in block 304, the following real polynomial is defined, wherein z is a real variable:

$${z}^{M} + {\sum }_{n = 1}^{M} {c}_{n} {z}^{M - n} = 0. \qquad Equation 19$$

The real roots zₘ of the real polynomial are then calculated, wherein m=0, 1, . . . , M−1.

Then, at block 308, estimates of the frequencies fₘ, wherein m=0, 1, . . . , M−1, are calculated from the following equation:

zₘ=μₘ=cos(2πfₘT). Equation 20

At block 310, the amplitude-related vector p is calculated from vectors q and r, using:

D⁻¹a=q

D⁻¹b=r Equation 21
p=[p₀ p₁ . . . p_{M-1}]^{T}
q=[q₀ q₁ . . . q_{M-1}]^{T}
r=[r₀ r₁ . . . r_{M-1}]^{T}
   wherein: vector a and vector b are defined at block 304, and D is a M×M matrix, the element d_{m,n} of line n and column m being defined as:

$${d}_{m , n} = \{ \begin{matrix}1 & n = 0 \\ {c}_{n} + {μ}_{m} {d}_{m , n - 1} & n = 1 , 2 , … , M - 1.\end{matrix} \\ Then , Re \{ {p}_{m} \} = {q}_{m} \\ Im \{ {p}_{m} \} = \frac{{r}_{m} - {q}_{m} {μ}_{m}}{{v}_{m}} . \qquad Equation 22$$

At block 312, from the components of the vector p calculated in block 310, estimates of the M amplitudes Aₘ, wherein m=0, 1, . . . , M−1, are calculated from the following equation:

$${A}_{m} = \frac{{p}_{m}}{[ 1 - {λ}_{m}^{N} ]} . \qquad Equation 23$$

At block 314, as an optional feature, the DFT frequency samples can be reconstructed from the estimated frequencies and amplitudes of the multi-tone signal. For each real single-tone signal sₘ(t)=Aₘe^{j2πf}^{ₘ}^{t}+Aₘ*e^{-j2πf}^{ₘ}^{t}, m=0, 1, . . . , M−1, of a multi-tone signal

$$s ( t ) = {\sum }_{m = 0}^{M - 1} {s}_{m} ( t ) ,$$

the N DFT frequency samples Sₘ(k), k=0, 1, . . . , N−1, are reconstructed using:

$${S}_{m} ( k ) = \frac{{q}_{m} {w}_{k}^{*} - {r}_{m}}{{u}_{k} - {μ}_{m}} ; \qquad Equation 24$$

wherein qₘ are elements of vector q, rₘ are elements of vector r, q and r being defined at block 310.

Sₘ(k) as defined hereinabove is the projection of the real single-tone of index m on the kₜₕ vector of the transformation matrix of the DFT of length N.

For a real multi-tone signal, the N DFT frequency samples S(k), k=0, 1, . . . , N−1 can be reconstructed using:

$$S ( k ) = {\sum }_{m = 0}^{M - 1} {S}_{m} ( k ) \\ S ( k ) = {u}_{k}^{- 1} \frac{{w}_{k}^{*} {\sum }_{m = 0}^{M - 1} {a}_{m} {u}_{k}^{- m} - {\sum }_{m = 0}^{M - 1} {b}_{m} {u}_{k}^{- m}}{1 + {\sum }_{m = 1}^{M} {c}_{m} {u}_{k}^{- m}} \qquad Equation 25$$

wherein Sₘ (k) is defined hereinabove, aₘ are the elements of vector a, bₘ are the elements of vector b and cₘ₊₁ are the elements of vector c, m=0, 1, . . . , M−1, vector a, vector b and vector c being defined at block 304.

S(k) as defined hereinabove for a multi-tone signal is the projection of the complex multi-tone signal on the kₜₕ vector of the transformation matrix of the DFT of length N.

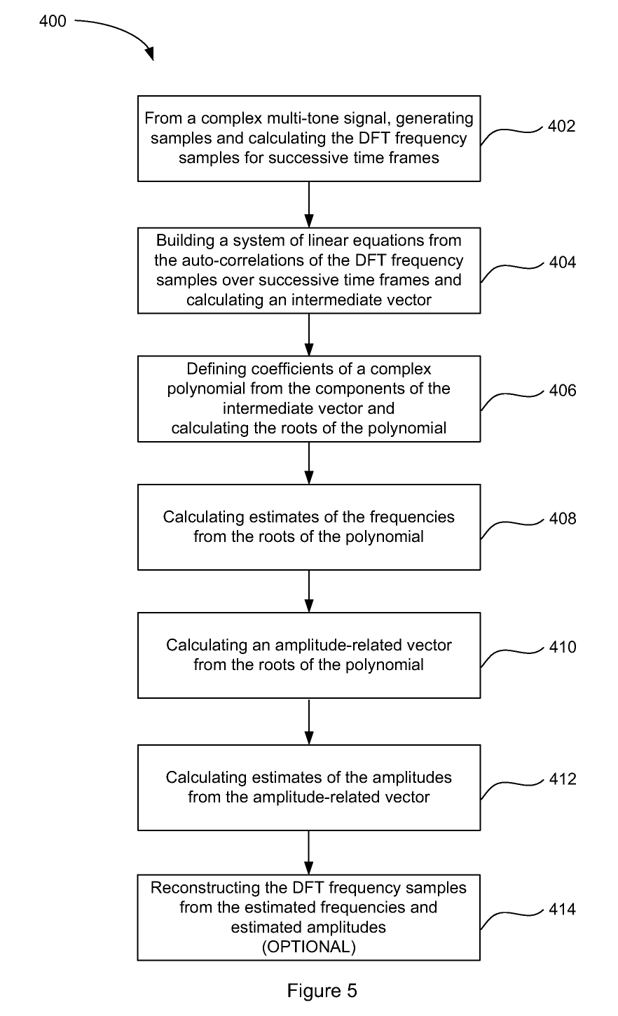

A third non-restrictive illustrative embodiment of the process 100 of FIG. 2 will now be described in FIG. 5 as process 400. Process 400 is used for estimating parameters of a complex multi-tone signal s(t) made up of at least one single-tone signal.

Referring to FIG. 5, the process 400 for estimating parameters of a complex multi-tone signal s(t) made up of at least one single-tone signal will now be described according to the third non-restrictive illustrative embodiment of process 100. The steps of the process 400 are indicated by blocks 402 to 414.

It is to be understood that blocks 402 to 414 of process 400 are specific implementations of the associated general blocks 102 to 114 of process 100 from FIG. 2.

The process 400 starts at block 402 where time samples of the multi-tone signal are generated. A total of N_{T}=N+M+L+L₀ samples s(lT), l₀≦l<l₀+N_{T} are generated wherein: l₀= . . . , −2, −1, 0, 1, 2, . . . , l₀ is the index of the first time frame used, M is the number of tones in the signal, N is the length of the DFT, and L and L₀ are integers with L≧0 and L₀≧0.

Using successive time frames s[(l+n)T], n=0, 1, . . . , N−1, the DFT frequency samples S(k,l) for time frames l₀≦l≦l₀+N_{T}−N are calculated, wherein:

$$S ( k , l ) = {\sum }_{n = 0}^{N - 1} s ( [ l + n ] T ) {e}^{- j \frac{2 π kn}{N}} . \qquad Equation 26$$

The DFT frequency samples S(k,l) for successive time frames are calculated using recursions:

S(k,l+1)=wₖ*[S(k,l)+s((l+N)T)−s(lT)]

S(k,l−1)=wₖS(k,l)+s([l−1]T)−s([l+N−1]T). Equation 27

The process 400 uses auto-correlations of the DFT frequency samples S(k,l) over successive time frames l. More specifically:

$$C ( k , m , τ ) = {\sum }_{l = {l}_{0} + M - m}^{{l}_{0} + M - m + L} {S}^{*} ( k , l ) S ( k , l + τ ) . \qquad Equation 28$$

At block 404, a system of linear equations is built. From the N DFT frequency samples S(k,l) of any time frames l, K DFT frequency samples are selected and auto-correlations of S(k,l) over successive time frames are calculated for each selected frequency sample. The K frequency samples are indexed by k₀, k₁, . . . , k_{K-1}. It is to be noted that in general, an index of the K frequency samples is denoted by kᵢ.

More specifically, the resulting system of linear equations is:

$$b = Ra \\ wherein \text{:} \\ a = {[ {a}_{1} {a}_{2} … {a}_{M} ]}^{T} \\ b = {[ {b}_{1} {b}_{2} … {b}_{M} ]}^{T} ; \\ R = [ \begin{matrix}{R}_{1 , 1} & {R}_{1 , 2} & … & {R}_{1 , M} \\ {R}_{2 , 1} & {R}_{2 , 2} & … & {R}_{2 , M} \\ … & … & … & … \\ {R}_{M , 1} & {R}_{2 , M} & … & {R}_{M , M}\end{matrix} ] \\ {b}_{m} = {\sum }_{i = 0}^{K - 1} C ( {k}_{i} , {L}_{0} + m ) \\ {R}_{m , n} = {\sum }_{i = 0}^{K - 1 } C ( {k}_{i} {L}_{0} + m - n ) ; \\ C ( {k}_{i} , τ ) = {\sum }_{l = {l}_{0} + M - m}^{{l}_{0} + M - m + L} {S}^{*} ( {k}_{i} , l ) S ( {k}_{i} , l + τ ) \\ L \geq 0 \\ and \\ {L}_{0} \geq 0. \qquad Equation 29$$

The solution of the system of linear equations is then calculated, such that:

R⁻¹b=a, Equation 30

defining the intermediate vector a.

The components of vector a are to be used as coefficients for defining a complex polynomial.

At block 406, the coefficients of the polynomial are defined and the roots of the polynomial are calculated. From the vector a as defined hereinabove in block 404 and a₀=−1, the following complex polynomial is defined, wherein z is a complex variable:

$${\sum }_{n = 0}^{M} {a}_{n} {z}^{- n} = 0 \qquad Equation 31$$

The roots zₘ of the complex polynomial are then calculated, wherein m=0, 1, . . . , M−1.

Then, at block 408, estimates of the frequencies fₘ, wherein m=0, 1, . . . , M−1, are calculated from the following equation:

zₘ=λₘ=e^{j2πf}^{ₘ}^{T}. Equation 32

At block 410, using the roots zₘ=λₘ calculated at block 406, a vector c pertaining to amplitudes is calculated, such that:

$${P}^{- 1} d = c , \\ wherein \text{:} \\ c = {[ {c}_{1} {c}_{2} … {c}_{M} ]}^{T} \\ d = {[ {d}_{1} {d}_{2} … {d}_{M} ]}^{T} ; \\ P = [ \begin{matrix}{P}_{1 , 1} & {P}_{1 , 2} & … & {P}_{1 , M} \\ {P}_{2 , 1} & {P}_{2 , 2} & … & {P}_{2 , M} \\ … & … & … & … \\ {P}_{M , 1} & {P}_{2 , M} & … & {P}_{M , M}\end{matrix} ] \\ {d}_{m} = {\sum }_{i = 0}^{K - 1} {\sum }_{l = 1}^{{L}_{2}} {λ}_{m}^{l} S ( {k}_{i} , {l}_{0} + {L}_{2} - l ) ; \\ {L}_{2} \geq 1. \\ {P}_{m , n} = K {\sum }_{l = 1}^{{L}_{2}} {λ}_{m}^{l} {λ}_{n}^{- 1} \qquad Equation 33$$

At block 412, from the components of vector c calculated in block 410 hereinabove and the roots zₘ=λₘ calculated at block 406, estimates of the M complex amplitudes Aₘ, wherein m=0, 1, . . . , M−1, are calculated from the following equation:

$${A}_{m} = \frac{{c}_{m}}{[ 1 - {λ}_{m}^{N} ] [ {\sum }_{i = 0}^{K - 1} \frac{1}{1 - {w}_{{k}_{i}} {λ}_{m}} ]} . \qquad Equation 34$$

At block 414, as an optional feature, the DFT frequency samples Sₘ(k), m=0, 1, . . . , M−1, of each complex single-tone signal making up the complex multi-tone signal and the DFT frequency samples S(k) of the multi-tone signal can be reconstructed. This is accomplished similarly to block 214 of process 200 of FIG. 3.

For the case of a complex single-tone signal with frequency f, with m₁≧0, m₂≧0 and m₁≠m₂, m₁ and m₂ integers, the frequency f can be obtained using:

$${e}^{j 2 π ( {m}_{1} - {m}_{2} ) fT} = {R}^{- 1} b ; \\ b = {\sum }_{i = 0}^{K - 1} C ( {k}_{i} , {m}_{1} ) \\ R = {\sum }_{i = 0}^{K - 1} C ( {k}_{i} , {m}_{2} ) ; \\ C ( {k}_{i} , τ ) = {\sum }_{l = {l}_{0}}^{{l}_{0} + {L}_{2}} {S}^{*} ( {k}_{i} , l ) S ( {k}_{i} , l + τ ) \\ wherein \\ {L}_{2} \geq 0. \qquad Equation 35$$

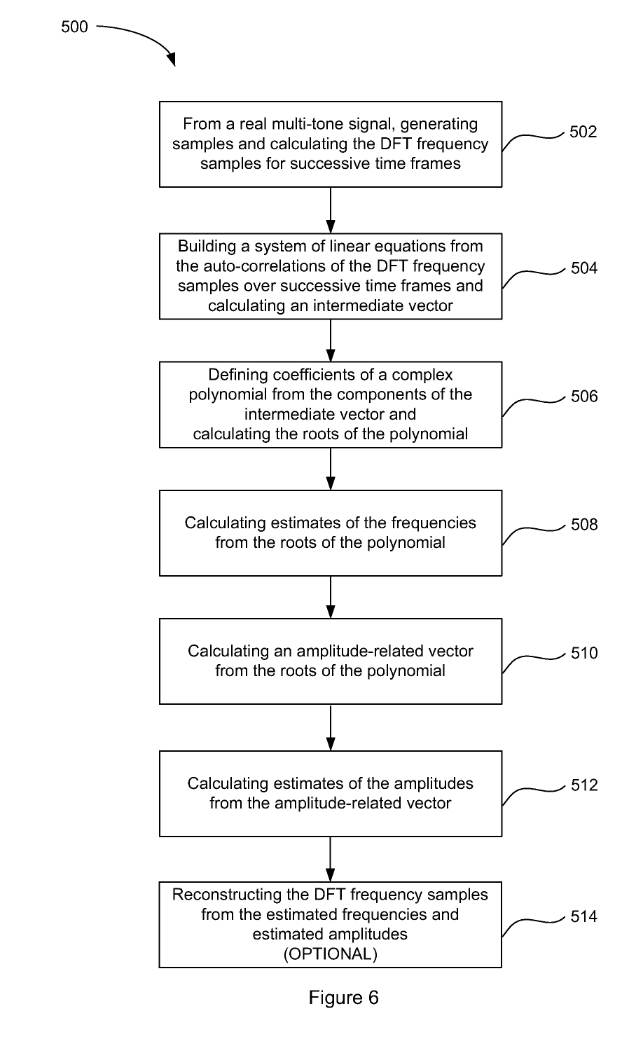

A fourth non-restrictive illustrative embodiment of the process 100 of FIG. 2 will now be described in FIG. 6 as process 500. Process 500 is used for estimating parameters of a real multi-tone signal s(t) made up of at least one single-tone signal.

It is to be noted that process 500 is adapted from process 400, since a real single-tone signal s(t) can always be viewed as the sum of two complex single-tone signals.

Referring to FIG. 6, the process 500 for estimating parameters of a real multi-tone signal s(t) made up of at least one single-tone signal will now be described according to the fourth non-restrictive illustrative embodiment of process 100. The steps of the process 500 are indicated by blocks 502 to 514.

It is to be understood that blocks 502 to 514 of process 500 are specific implementations of the associated general blocks 102 to 114 of process 100 from FIG. 2.

The process 500 starts at block 502 where time samples of the multi-tone signal are generated. A total of N_{T}=N+2M+L+L₀ samples s(lT), l₀≦l≦l₀+N_{T} are generated wherein: M is the number of tones in the signal, N is the length of the DFT and L and L₀ are integers with L≧0 and L₀≧0.

From the time samples, the DFT frequency samples S(kᵢ,l), k₀, k₁, . . . , k_{K-1}, are calculated for successive time frames 1. This is accomplished similarly to block 402 of process 400 of FIG. 5 with the exception that the signal s(t) is a real signal made up of M real single-tone signals.

The process 500 uses mixed auto-correlations of the DFT frequency samples S (k,l) over successive time frames l. More specifically:

$$C ( k , m , n , τ ) = {\sum }_{l = {l}_{0}}^{{l}_{0} + L} Ψ ( k , l + M , m ) {Ψ}^{*} ( k , l + M + τ , n ) \\ Ψ ( k , i , m ) = S ( k , i + m ) + S ( k , i - m ) . \qquad Equation 36$$

At block 504, a system of linear equations is built. From the N DFT frequency samples S(k,l) of any time frames 1, K DFT frequency samples are selected and mixed auto-correlations of S(k,l) over successive time frames are calculated for each selected frequency samples. The K frequency samples are indexed by k₀, k₁, . . . k_{K-1}. It is to be noted that in general, an index of the K frequency samples is denoted by kᵢ.

More specifically, the resulting system of linear equations is:

$$b = Ra \\ wherein \text{:} \\ a = {[ {a}_{1} {a}_{2} … {a}_{M} ]}^{T} \\ b = {[ {b}_{1} {b}_{2} … {b}_{M} ]}^{T} ; \\ R = [ \begin{matrix}{R}_{1 , 1} & {R}_{1 , 2} & … & {R}_{1 , M} \\ {R}_{2 , 1} & {R}_{2 , 2} & … & {R}_{2 , M} \\ … & … & … & … \\ {R}_{M , 1} & {R}_{2 , M} & … & {R}_{M , M}\end{matrix} ] \\ {b}_{m} = \frac{1}{2} {\sum }_{i = 0}^{K - 1} Re \{ C ( {k}_{i} , m , 0 , {L}_{0} ) \} \\ {R}_{m , n} = {\sum }_{i = 0}^{K - 1 } Re \{ C ( {k}_{i} , m , n , {L}_{0} ) \} ; \\ C ( {k}_{i} , m , n , τ ) = {\sum }_{l = {l}_{0}}^{{l}_{0} + L} Ψ ( {k}_{i} , l + M , m ) {Ψ}^{*} ( {k}_{i} , l + M + τ , n ) \\ Ψ ( {k}_{i} , h , m ) = S ( {k}_{i} , h + m ) + S ( {k}_{i} , h - m ) \\ and \\ L \geq 0 \\ and \\ {L}_{0} \geq 0. \qquad Equation 37$$

The solution of the system of linear equations is then calculated, such that:

R⁻¹b=a, Equation 38

defining the intermediate vector a.

The components of vector a are to be used as coefficients for defining a complex polynomial.

At block 506, the coefficients of the polynomial are defined and the roots of the polynomial are calculated. From the vector a as defined hereinabove in block 504, the following complex polynomial is defined, wherein z is a complex variable:

$${\sum }_{n = - M}^{M} {a}_{n} {z}^{- n} = 0 \\ with \\ {a}_{- n} = {a}_{n} \\ and \\ {a}_{0} = - 1.0 . \qquad Equation 39$$

The roots zₘ of the complex polynomial are then calculated, wherein m=0, 1, . . . , 2M−1. As it is known by those skilled in the art, because the signal is real, roots always come in pairs: for any root zₘ, there is a root zₘ* which is the conjugate of zₘ.

Then, at block 508, estimates of the frequencies fₘ, wherein m=0, 1, . . . , M−1, are calculated from the following equation:

zₘ=λₘ=e^{j2πf}^{ₘ}^{T} Equation 40

wherein the roots zₘ used are those with positive imaginary part.

At block 510, using the frequencies fₘ calculated at block 508, a vector c pertaining to amplitudes is calculated, such that:

$${P}^{- 1} d = c , \\ wherein \text{:} \\ c = {[ {c}_{1} {c}_{2} … {c}_{M} ]}^{T} \\ d = {[ {d}_{1} {d}_{2} … {d}_{M} ]}^{T} ; \\ P = [ \begin{matrix}{P}_{1 , 1} & {P}_{1 , 2} & … & {P}_{1 , M} \\ {P}_{2 , 1} & {P}_{2 , 2} & … & {P}_{2 , M} \\ … & … & … & … \\ {P}_{M , 1} & {P}_{2 , M} & … & {P}_{M , M}\end{matrix} ] \\ {d}_{m} = \frac{1}{2} {\sum }_{l = 1}^{{L}_{2}} cos ( 2 π ( l + {L}_{0} ) {f}_{m} T ) Ψ ( {k}_{i} , {l}_{0} + {L}_{2} + M , l ) \\ {P}_{m , n} = {\sum }_{l = 1}^{{L}_{2}} cos ( 2 π ( l + {L}_{0} ) {f}_{m} T ) cos ( 2 π {lf}_{n} T ) ; \\ Ψ ( {k}_{i} , h , l ) = S ( {k}_{i} , h + l ) + S ( {k}_{i} , h - l ) \\ and \\ {L}_{2} \geq 1. \qquad Equation 41$$

At block 512, from the components of vector c calculated in block 510 hereinabove and the frequencies fₘ calculated at block 508, the parameter pₘ is calculated such that:

$$Re \{ {p}_{m} \} = \frac{Im \{ {c}_{m} \} [ {u}_{{k}_{i}} - {γ}_{m} ]}{{v}_{{k}_{i}}} \\ Im \{ {p}_{m} \} = \frac{[ Re \{ {c}_{m} \} - Re \{ {p}_{m} \} ] [ {u}_{{k}_{i}} - {μ}_{m} ]}{{v}_{m}} \qquad Equation 42$$

Then, estimates of the M complex amplitudes Aₘ, wherein m=0, 1, . . . , M−1, are calculated from the following equation:

$${A}_{m} = \frac{{p}_{m}}{[ 1 - {λ}_{m}^{N} ]} . \qquad Equation 43$$

At block 514, as an optional feature, the DFT frequency samples Sₘ(k), m=0, 1, . . . , M−1, of each real single-tone signal making up the real multi-tone signal and the DFT frequency samples S(k) of the multi-tone signal can be reconstructed. This is accomplished similarly to block 314 of process 300 of FIG. 4.

For the case of a real single-tone signal with frequency f, with m₁≧0, m₂≧0 and m₁≠m₂, m₁ and m₂ integers, the frequency f can be obtained using:

$$\frac{cos ( 2 π {m}_{1} fT )}{cos ( 2 π {m}_{2} fT )} = {R}^{- 1} b ; \\ b = {\sum }_{i = 0}^{K - 1} Re \{ C ( {k}_{i} , {m}_{1} ) \} \\ R = {\sum }_{i = 0}^{K - 1} Re \{ C ( {k}_{i} , {m}_{2} ) \} \\ C ( {k}_{i} , m ) = {\sum }_{l = {l}_{0} + m}^{{l}_{0} + m + L} Ψ ( {k}_{i} , l , m ) {Ψ}^{*} ( {k}_{i} , l , 0 ) \\ Ψ ( {k}_{i} , l , m ) = S ( {k}_{i} , l + m ) + S ( {k}_{i} , l - m ) ; \\ wherein {L}_{2} \geq 0. \qquad Equation 44$$

It is to be understood that although the reconstruction of the DFT frequency samples at block 214, 314, 414 and 514 uses the estimated frequencies and amplitudes of the multi-tone signal, the exact values of the frequencies and amplitudes, as well as estimates of the frequencies and amplitudes obtained from other methods or means, may also be used.

### Theoretical Background

In the present invention, the DFT is used as a linear transformation as defined in vector space theory [8]. As a linear transformation, the DFT of length N can be represented by a transformation matrix composed of N vectors:

wₖ=[1wₖwₖ² . . . wₖ^{N-1}]^{T} Equation 45

wherein k=0, 1, . . . , N−1 and

$${w}_{k} = {e}^{- j \frac{2 π k}{N}}$$

is defined in Equation 1.

The set of N vectors wₖ, k=0, 1, . . . , N−1, of the DFT transformation matrix forms an orthogonal basis of the vector space

$${w}_{m}^{T} {w}_{n} = \{ \begin{matrix}N , & m = n \\ 0 , & m \neq n .\end{matrix} \qquad Equation 46$$

The time samples s(nT) of the signal s(t) are projected on vector k of the DFT transformation matrix to give the DFT frequency sample S(k):

$$S ( k ) = {\sum }_{n = 0}^{N - 1} s ( nT ) {w}_{k}^{n} \qquad Equation 47$$

For a complex single-tone signal with frequency f and amplitude A, the time samples s(nT) and the DFT frequency samples are given by:

$$\begin{matrix}s ( nT ) = A {e}^{j 2 π nfT} \\ S ( k ) = {\sum }_{n = 0}^{N - 1} A {e}^{j 2 π nfT} {w}_{k}^{n} , \\ = \frac{p}{1 - {w}_{k} λ} \\ wherein \text{:} \\ λ = {e}^{j 2 π fT} and \\ p = A ( 1 - {λ}^{N} ) .\end{matrix} \qquad Equation 48$$

Multiplying both side of Equation 48 by the denominator, it is possible to set the following linear equation:

$$S ( k ) = [ \begin{matrix}1 & S ( k ) {w}_{k}\end{matrix} ] [ \begin{matrix}p \\ λ\end{matrix} ] . \qquad Equation 49$$

Using two DFT frequency samples S(k₀) and S(k₁), it is possible to build the following system of linear equations:

$$[ \begin{matrix}S ( {k}_{0} ) \\ S ( {k}_{1} )\end{matrix} ] = [ \begin{matrix}1 & S ( {k}_{0} ) {w}_{{k}_{0}} \\ 1 & S ( {k}_{1} ) {w}_{{k}_{1}}\end{matrix} ] [ \begin{matrix}p \\ λ\end{matrix} ] . \qquad Equation 50$$

Providing the matrix is non-singular, intermediate vector [p λ]^{T} can be calculated from which the frequency f and the amplitude A can be obtained.

For a complex multi-tone signal, using the linearity property of the DFT, the DFT frequency sample S(k) is given by:

$$S ( k ) = {\sum }_{m = 0}^{M - 1} \frac{{p}_{m}}{1 - {w}_{k} {λ}_{m}} . \qquad Equation 51$$

It is possible to show that the DFT frequency sample S(k) in Equation 51 is also given by:

$$S ( k ) = \frac{{\sum }_{n = 0}^{M - 1} {a}_{n} {w}_{k}^{n}}{1 + {w}_{k} {\sum }_{n = 0}^{M - 1} {b}_{n + 1} {w}_{k}^{n}} . \qquad Equation 52$$

Multiplying both side of Equation 52 with the denominator on the right and rearranging the equation gives:

$$S ( k ) = {\sum }_{n = 0}^{M - 1} {a}_{n} {w}_{k}^{n} - S ( k ) {w}_{k} {\sum }_{n = 0}^{M - 1} {b}_{n + 1} {w}_{k}^{n} \qquad Equation 53$$

and the DFT value on the left is a linear combination of the unknown parameters aₙ and bₙ₋₁ for n=0, 1, . . . , M−1. The complete system of 2M linear equations with 2M unknowns of block 204 of FIG. 3 can be established, and providing the matrix is non-singular, the intermediate unknown parameters aₙ and bₙ₊₁ for n=0, 1, . . . , M−1 can be calculated. It can be shown that all the frequencies fₘ and amplitudes Aₘ, m=0, 1, . . . , M−1, can be recovered from the intermediate parameters aₙ and bₙ₊₁.

The DFT frequency sample S(k) of a real single-tone signal is given by:

$$S ( k ) = \frac{p}{1 - {w}_{k} λ} + \frac{{p}^{*}}{1 - {w}_{k} {λ}^{*}} . \qquad Equation 54$$

Merging the two rational functions, the DFT frequency sample S(k) of a real single-tone signal is given by:

$$S ( k ) = \frac{{w}_{k}^{*} q - r}{{u}_{k} - μ} , \qquad Equation 55$$

wherein: q, r, μ and uₖ are given in Equation 1.

Multiplying both side of Equation 55 by the denominator and re-arranging the equation gives:

$$S ( k ) {u}_{k} = [ \begin{matrix}{w}_{k}^{*} & - 1 & S ( k )\end{matrix} ] [ \begin{matrix}q \\ r \\ μ\end{matrix} ] . \qquad Equation 56$$

The vector of unknown parameters on the right being real, the last complex linear equation can be split into two real linear equations:

$$[ \begin{matrix}{S}_{r} ( k ) {u}_{k} \\ {S}_{i} ( k ) {u}_{k}\end{matrix} ] = [ \begin{matrix}{u}_{k} & - 1 & {S}_{r} ( k ) \\ {v}_{k} & 0 & {S}_{i} ( k )\end{matrix} ] [ \begin{matrix}\begin{matrix}q \\ r\end{matrix} \\ μ\end{matrix} ] . \qquad Equation 57$$

A set of three linear equations can be built to have a complete system of linear equations. The solution of this system of linear equations gives intermediary parameters q, r and μ from which it is possible to get the real frequency f and the complex amplitude A of the real single-tone signal.

With the linearity property of the DFT, it is possible to show that the system of linear equations of block 304 of FIG. 4 can be built.

Although the present invention has been described by way of illustrative embodiments and examples thereof, it should be noted that it will be apparent to persons skilled in the art that modifications may be applied to the present particular embodiment without departing from the scope of the present invention.

### REFERENCES

[1] R. Prony, “Essa: Expérimentale et analytique,” J. Ecole Polytechnique, pp. 24-76, 1795.
[2] V. Pisarenko, “The retrieval or harmonies from a covariance function,” Geophys. J. R. Astron. Soc, vol. 33, pp. 347-366, 1973.
[3] R. Schmidt, “Multiple emitter location and signal parameter estimation,” IEEE Trans. Antennas and Propagation, vol. AP34, pp. 276-280, Mar. 1986.
[4] R. Roy, A. Paulraj, and T. Kailath, “Esprit: A subspace rotation approach to estimation of parameters of cisoids in noise,” IEEE Trans. Acoustics, Speech and Signal Processing, vol. ASSP34, pp. 1340-1342, October 1986.
[5] H. So and F. W. Chan, “A generalized weighted linear predictor frequency estimation approach for a complex sinusoid,” IEEE Trans. on Signal Processing, vol. 54, pp. 1304-1315, April 2006.
[6] S. Kay, “A fast and accurate single frequency estimator,” IEEE Trans. Acoustics, Speech and Signal Processing, vol. ASSP37, pp. 1987-1989, December 1989.
[7] P. Stoica, R. Moses, T. Soderstrom, and J. Li, “Optimal high-order Yule-Walker estimation of sinusoidal frequencies,” IEEE Trans. on Signal Processing, vol. 39, pp. 1350-1368, June 1991.
[8] K. Hoffman and R. Kunze, “Linear Algebra,” Englewood Cliffs, N.J.: Prentice-Hall, 1971.

1. A method for estimating the frequency and the amplitude of each single-tone signal making up a multi-tone signal, comprising the steps of:
generating time samples of the multi-tone signal;
calculating Discrete Fourier Transform frequency samples from the time samples;
building a system of linear equations from the frequency samples;
defining the intermediate vector from a solution of the system of linear equations;
defining coefficients of a polynomial from components of the intermediate vector;
calculating roots of the polynomial;
calculating an amplitude-related vector from at least the roots of the polynomial;
calculating an estimate of the frequency of each single-tone signal from the roots of the polynomial; and
calculating an estimate of the amplitude of each single-tone signal from the amplitude-related vector.

2. A method according to claim 1, wherein the multi-tone signal is a complex multi-tone signal and the time samples are generated for one time frame.

3. A method according to claim 2, wherein the amplitude-related vector is calculated from the roots of the polynomial and the intermediate vector.

4. A method according to claim 3, wherein the time frame is selected such that the number of time samples is at least equal to twice the number of single-tone signals making up the complex multi-tone signal.

5. A method according to claim 4, wherein the number of equations in the system of linear equations is at least equal to twice the number of single-tone signals making up the complex multi-tone signal.

6. A method according to claim 1, wherein the multi-tone signal is a real multi-tone signal and the time samples are generated for one time frame.

7. A method according to claim 6, wherein the amplitude-related vector is calculated from the roots of the polynomial and the intermediate vector.

8. A method according to claim 7, wherein the time frame is selected such that the number of time samples is at least equal to three times the number of single-tone signals making up the real multi-tone signal.

9. A method according to claim 8, wherein a system of linear equations is built using real parts and imaginary parts of the calculated frequency samples.

10. A method according to claim 9, wherein the number of equations in the system of linear equations is equal to at least three times the number of single-tone signals making up the real multi-tone signal.

11. A method according to claim 1, wherein the multi-tone signal is a complex multi-tone signal and the time samples are generated for successive time frames.

12. A method according to claim 11, wherein the frequency samples are calculated using recursions.

13. A method according to claim 12, further comprising the step of calculating auto-correlations of the frequency samples over the successive times frames.

14. A method according to claim 13, wherein the system of linear equations is built using the auto-correlations of the frequency samples.

15. A method according to claim 14, wherein the number of equations in the system of linear equations is equal to at least the number of single-tone signals making up the complex multi-tone signal.

16. A method according to claim 1, wherein the multi-tone signal is a real multi-tone signal and the time samples are generated for successive time frames.

17. A method according to claim 16, wherein the frequency samples are calculated using recursions.

18. A method according to claim 17, further comprising the step of calculating mixed auto-correlations of the frequency samples over successive time frames.

19. A method according to claim 18, wherein the system of linear equations is built using the mixed auto-correlations of the frequency samples.

20. A method according to claim 19, wherein the number of equations in the system of linear equations is equal to at least the number of single-tone signals making up the real multi-tone signal.

21. A method according to claim 1, further comprising the step of calculating the reconstruction of the DFT frequency samples of each single-tone making up the multi-tone signal and the reconstruction of the DFT frequency samples of the multi-tone signal using the estimated frequencies and the estimated amplitudes of the multi-tone signal.

22. A system for estimating the frequency and the amplitude of each single-tone signal making up a multi-tone signal, the system comprising:
a sampler for generating time samples of the multi-tone signal;
an input/output interface; and
a processing unit operatively connected to the sampler and the input/output interface, the processing unit being so configured as to:
calculating Discrete Fourier Transform frequency samples from the time samples generated by the sampler;
building a system of linear equations from the frequency samples;
defining an intermediate vector from a solution of the system of linear equations;
defining coefficients of a polynomial from components of the intermediate vector;
calculating roots of the polynomial;
calculating an amplitude-related vector from at least the roots of the polynomial;
calculating an estimate of the frequency of each single-tone signal from the roots of the polynomial;
calculating an estimate of the amplitude of each single-tone signal from the amplitude-related vector; and
providing the estimated frequencies and the estimated amplitudes to the input/output interface.

23. A system according to claim 22, wherein the multi-tone signal is a complex multi-tone signal and the time samples are generated for one time frame.

24. A system according to claim 23, wherein the amplitude-related vector is calculated from the roots of the polynomial and the intermediate vector.

25. A system according to claim 24, wherein the time frame is selected such that the number of time samples is at least equal to twice the number of single-tone signals making up the complex multi-tone signal.

26. A system according to claim 25, wherein the number of equations in the system of linear equations is at least equal to twice the number of single-tone signals making up the complex multi-tone signal.

27. A system according to claim 22, wherein the multi-tone signal is a real multi-tone signal and the time samples are generated for one time frame.

28. A system according to claim 27, wherein the amplitude-related vector is calculated from the roots of the polynomial and the intermediate vector.

29. A system according to claim 28, wherein the time frame is selected such that the number of time samples is at least equal to three times the number of single-tone signals making up the real multi-tone signal.

30. A system according to claim 29, wherein a system of linear equations is built using real parts and imaginary parts of the calculated frequency samples.

31. A system according to claim 30, wherein the number of equations in the system of linear equations is equal to at least three times the number of single-tone signals making up the real multi-tone signal.

32. A system according to claim 22, wherein the multi-tone signal is a complex multi-tone signal and the time samples are generated for successive time frames.

33. A system according to claim 32, wherein the frequency samples for successive time frames are calculated using recursions.

34. A system according to claim 33, wherein the processing unit is further configured so as to calculate auto-correlations of the frequency samples over successive time frames.

35. A system according to claim 34, wherein the system of linear equations is built using the auto-correlations of the frequency samples.

36. A system according to claim 35, wherein the number of equations in the system of linear equations is equal to at least the number of single-tone signals making up the complex multi-tone signal.

37. A system according to claim 22, wherein the multi-tone signal is a real multi-tone signal and the time samples are generated for successive time frames.

38. A system according to claim 37, wherein the frequency samples are calculated using recursions.

39. A system according to claim 38, wherein the processing unit is further configured so as to calculate mixed auto-correlations of the frequency samples over successive time frames.

40. A system according to claim 39, wherein the system of linear equations is built using the mixed auto-correlations of the frequency samples.

41. A system according to claim 40, wherein the number of equations in the system of linear equations is equal to at least the number of single-tone signals making up the real multi-tone signal.

42. A system according to claim 22, wherein the processing unit is further configured so as to calculate the reconstruction of the DFT frequency samples of each single-tone making up the multi-tone signal and the reconstruction of the DFT frequency samples of the multi-tone signal using the estimates of the frequencies and the estimates of the amplitudes of the multi-tone signal, and providing the reconstructed DFT frequency samples.
